(19) United States
(12) Patent Application Publication
(10) Pub. No.: US 2026/0046535 A1
(43) Pub. Date: Feb. 12, 2026

(54) DUAL-MODE PHOTODETECTOR PIXEL CIRCUIT

(71) Applicant: PixArt Imaging Incorporation, HsinChu (TW)

(72) Inventors: Wooi-Kip Lim, Penang (MY); Shan-Chong Tan, Penang (MY)

(21) Appl. No.: 18/801,484

(22) Filed: Aug. 12, 2024

(51) Int. Cl. H04N 25/771

(52) U.S. Cl. CPC H04N 25/771

(57) ABSTRACT

A photodetector pixel circuit includes a phototransistor which includes a photovoltaic junction, wherein the photovoltaic junction generates a junction current in response to received light, the level of the junction current being related to the intensity of the light; and a storage capacitor, coupled to the phototransistor for detecting the intensity of the light. In a phototransistor mode, the storage capacitor is configured to integrate an amplified current, generated by the phototransistor amplifying the junction current with a phototransistor current gain which is larger than 1, to generate a light intensity signal representing the intensity of the light. In a photodiode mode, the storage capacitor is configured to integrate the junction current to generate the light intensity signal.

### BACKGROUND OF THE INVENTION

### Field of Invention

The present invention relates to a photodetector pixel circuit; particularly it relates to a photodetector pixel circuit supporting dual operation modes.

### Description of Related Art

FIG. 1 shows a schematic diagram of a prior art photodetector pixel circuit. When the photodetector pixel circuit 100 is activated (at time to), VPBB will be biased to provide a bias current supply from supply voltage VDDA to the transistor M4 through the inverting node CGN. Once the light to be detected shines on the photovoltaic junction at time t1 (i.e., the base to collector junction of the photovoltaic BJT QP), a small base current IB will be generated as shown on FIG. 1. Level of the base current IB is positively proportional to the light intensity. The amplifier circuit 20, comprising transistor M4 and M5, starts to establish a proper biasing voltage (i.e. base-emitter voltage VBE) across the emitter and base of the photovoltaic BJT QP when the light is shone on the base to obtain a stable phototransistor current gain β which is around 30. The brighter the light, the higher the base-emitter voltage VBE is. The time required from the LED providing the light ON until the phototransistor current gain β settles to stable is called a pre-flash time (time t1 to t2).

Shutter is subsequently exposed (INTN=0) to discharge the storage capacitor C after the pre-flash time. The current to discharge the storage capacitor C is around a product of the base current and the phototransistor current gain β, i.e., IB×β.

The high phototransistor current gain in the photovoltaic BJT enables a lower integration time and thus higher frame rate in applications such as gaming mouse sensor thanks to the higher discharging current, but comes with the side effect of higher shot noise. The higher shot noise causes performance issue in applications requiring high SNR (signal-to-noise ratio) such as mouse sensor supporting track-on-glass.

To meet both requirements in a single photodetector pixel circuit, the photodetector pixel circuit of the present invention circuit aims to support dual mode with minimum circuit cost and complexity.

### SUMMARY OF THE INVENTION

From one perspective, the present invention provides a photodetector pixel circuit, comprising: a phototransistor, including a photovoltaic junction, wherein the photovoltaic junction generates a junction current in response to received light, the level of the junction current being related to the intensity of the light; and a storage capacitor, coupled to the phototransistor for detecting the intensity of the light; and wherein in a phototransistor mode, the storage capacitor is configured to integrate an amplified current, generated by the phototransistor amplifying the junction current with a phototransistor current gain which is larger than 1, to generate a light intensity signal representing the intensity of the light, wherein in a photodiode mode, the storage capacitor is configured to integrate the junction current to generate the light intensity signal.

In one embodiment, for generating the light intensity signal in response to a same light intensity, a first integration time is required in the phototransistor mode and a second integration time is required in the photodiode mode, wherein a ratio between the second integration time to the first integration time is greater than 1 and is related to the phototransistor current gain.

In one embodiment, a signal-to-noise ratio (SNR) of the light intensity signal is higher in the photodiode mode than in the phototransistor mode.

In one embodiment, the phototransistor is a photovoltaic bipolar-junction-transistor (BJT), wherein the photovoltaic junction corresponds to a base-collector junction of the photovoltaic BJT, wherein the junction current corresponds to a base current flowing through the base of the photovoltaic BJT, wherein the amplified current corresponds to an emitter current flowing through the emitter of the photovoltaic BJT.

In one embodiment, the photodetector pixel circuit of further comprises a swap switch, configured to conduct the junction current to integrate the storage capacitor in the photodiode mode.

In one embodiment, the photodetector pixel circuit of further comprises an amplifier circuit, configured to, in the phototransistor mode, amplify a voltage at the base of the photovoltaic BJT to regulate a voltage at the emitter of the photovoltaic BJT to a level, whereby the photovoltaic BJT is biased in an active region to provide the phototransistor current gain and to conduct the storage capacitor to the amplified current for integration.

In one embodiment, the photodetector pixel circuit of further comprises a bias current; wherein in the phototransistor mode, the bias current is provided to bias the amplifier circuit to operate; wherein in the photodiode mode, provision of the bias current for biasing the amplifier circuit is stopped, thereby the amplified current stops being generated and cut off from the storage capacitor.

In one embodiment, the photodetector pixel circuit of further comprises a reset switch, configured to reset the light intensity signal before the storage capacitor being integrating in the phototransistor mode or the photodiode mode; and an integration switch, configured to conduct the storage capacitor for being integrating in the phototransistor mode or the photodiode mode.

In one embodiment, the photodetector pixel circuit of further comprises a pre-bias transistor, wherein the amplifier circuit includes a first amplifying transistor and a second amplifying transistor, wherein the pre-bias transistor is connected between a supply voltage and a pre-bias node, the integration switch is connected between the pre-bias node and the storage capacitor, the reset switch is connected between the storage capacitor and the supply voltage, the swap switch is connected between the pre-bias node and the base of the photovoltaic BJT, a gate and a drain of the first amplifying transistor are connected to the base of the photovoltaic BJT and an inverting node respectively, and a gate, a drain and a source of the second amplifying transistor are connected to the inverting node, the pre-bias node and the emitter of the photovoltaic BJT respectively.

In one embodiment, during an integration phase in the phototransistor mode, the bias current is provided through the inverting node to bias the first amplifying transistor which amplifies the voltage at the base of the photovoltaic BJT to generate an amplified signal on the inverting node, and the second amplifying transistor amplifies the amplified signal to regulate the voltage at the emitter of the photovoltaic BJT for biasing the photovoltaic BJT in the active region, wherein the storage capacitor integrates the emitter current through the second amplifying transistor to generate the light intensity signal, and wherein the swap switch is controlled to be off; wherein during an integration phase in the photodiode mode, provision of the bias current is stopped, thereby cutting off the second amplifier transistor to electrically disconnect the emitter of the photovoltaic BJT from the storage capacitor, and wherein the swap switch is controlled to be conductive, thereby the storage capacitor integrates the base current through the swap switch to generate the light intensity signal.

The objectives, technical details, features, and effects of the present invention will be better understood with regard to the detailed description of the embodiments below.

### BRIEF DESCRIPTION OF THE DRAWINGS

FIG. 1 shows a schematic diagram of a prior art photodetector pixel circuit.

FIG. 2 shows a block diagram of an embodiment of a photodetector pixel circuit according to the present invention.

FIG. 3 shows a schematic diagram of an embodiment of a photodetector pixel circuit according to the present invention.

FIG. 4A and FIG. 4B show operational schematic diagrams of an embodiment of a photodetector pixel circuit according to the present invention.

FIG. 5 shows a simulation waveform diagram of an embodiment of a photodetector pixel circuit according to the present invention.

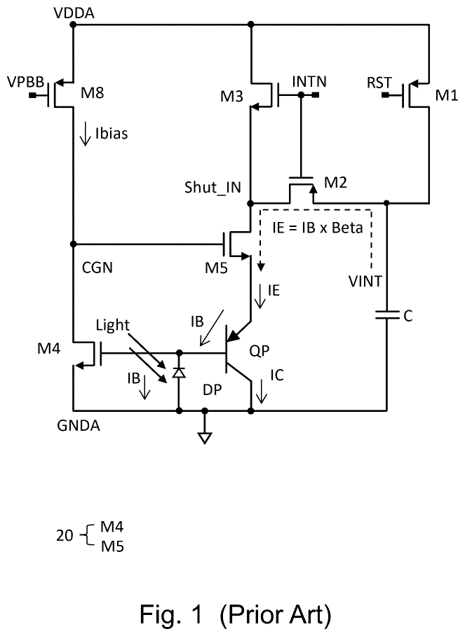

### DESCRIPTION OF THE PREFERRED EMBODIMENTS

The drawings as referred to throughout the description of the present invention are for illustration only, to show the interrelations between the circuits and the signal waveforms, but not drawn according to actual scale.

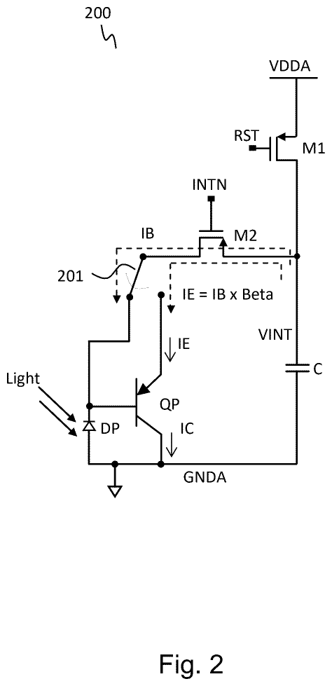

FIG. 2 shows a conceptual schematic diagram of an embodiment of a photodetector pixel circuit according to the present invention. The photodetector pixel circuit 200 comprises a phototransistor QP, a storage capacitor C, a reset switch M1, and integration switch M2 and a swap switch 201.

The reset switch M1 is configured to reset the light intensity signal VINT (pull up to VDDA) before the storage capacitor C integrates currents in response to light. The integration switch M2 is configured to conduct the storage capacitor C for being integrating.

The phototransistor includes a photovoltaic junction DP which generates a junction current in response to received light. In one embodiment, the phototransistor is a photovoltaic bipolar-junction-transistor (BJT) QP as shown in FIG. 2. In this embodiment, the aforementioned photovoltaic junction DP corresponds to a base-collector junction of the photovoltaic BJT QP, and the junction current corresponds to a base current IB flowing through the base of the photovoltaic BJT QP. The level of the junction current (base current IB) is related to the intensity of the light.

The swap switch 201 is configured to switch the storage capacitor C to integrate either the base current IB in a photodiode mode, or the emitter current IE, an amplified version of IB, in a phototransistor mode, thereby generating the light intensity signal VINT, whose level is inversely proportional to the intensity of the received light in this embodiment.

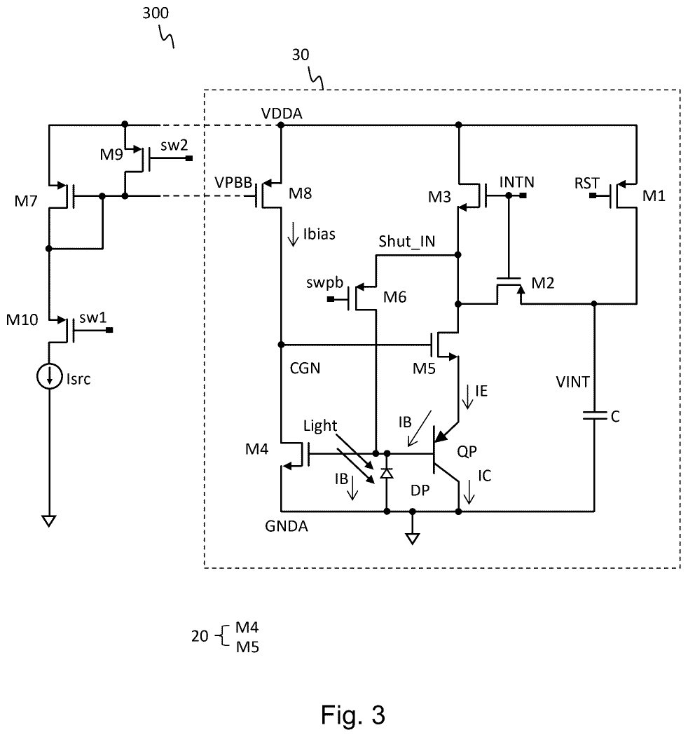

FIG. 3 shows a schematic diagram of a specific embodiment of a photodetector pixel circuit according to the present invention.

In this specific embodiment, the photodetector pixel circuit 30 further comprises a pre-bias transistor M3, a first amplifying transistor M4, a second amplifying transistor M5 and a biasing transistor M8. The first amplifying transistor M4 and the second amplifying transistor M5 form an amplifier circuit 20. A plurality of the photodetector pixel circuit can be arranged as a single or multi-dimensional pixel array. The mirroring transistor M7 mirrors a source current Isrc for the biasing transistor M8 to generate a biasing current Ibias. The biasing control switches M9 and M10 control the provision of the biasing current.

More specifically, in this embodiment, the pre-bias transistor M3 is connected between a supply voltage VDDA and a pre-bias node Shut_IN, the integration switch M2 is connected between the pre-bias node Shut_IN and the storage capacitor C, the reset switch M1 is connected between the storage capacitor C and the supply voltage VDDA, the swap switch M6 is connected between the pre-bias node Shut_IN and the base of the photovoltaic BJT QP, a gate and a drain of the first amplifying transistor M4 are connected to the base of the photovoltaic BJT QP and an inverting node CGN respectively, and a gate, a drain and a source of the second amplifying transistor M5 are connected to the inverting node CGN, the pre-bias node Shut_IN and the emitter of the photovoltaic BJT QP respectively.

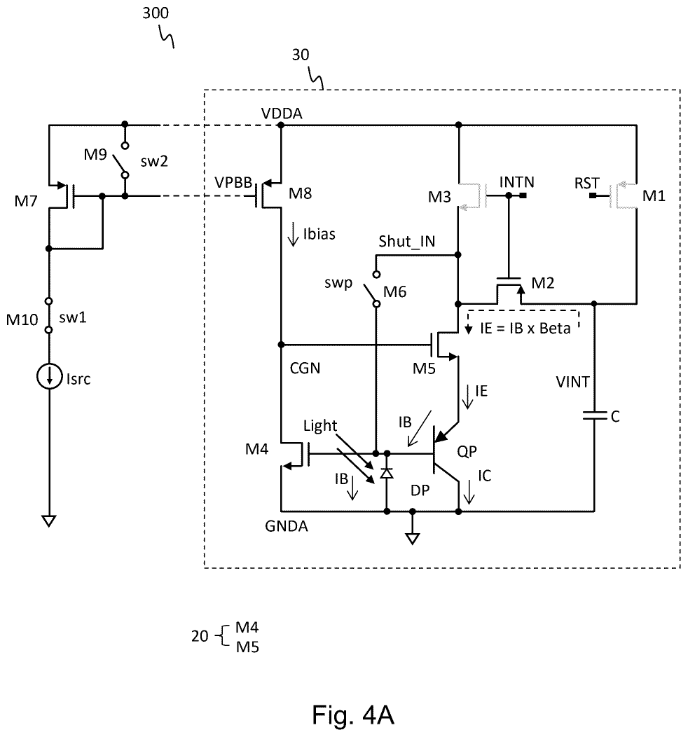

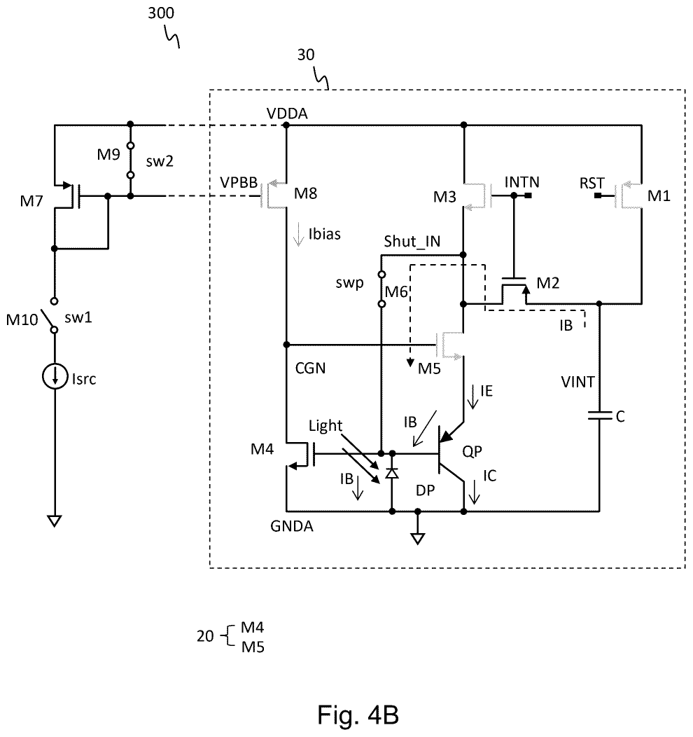

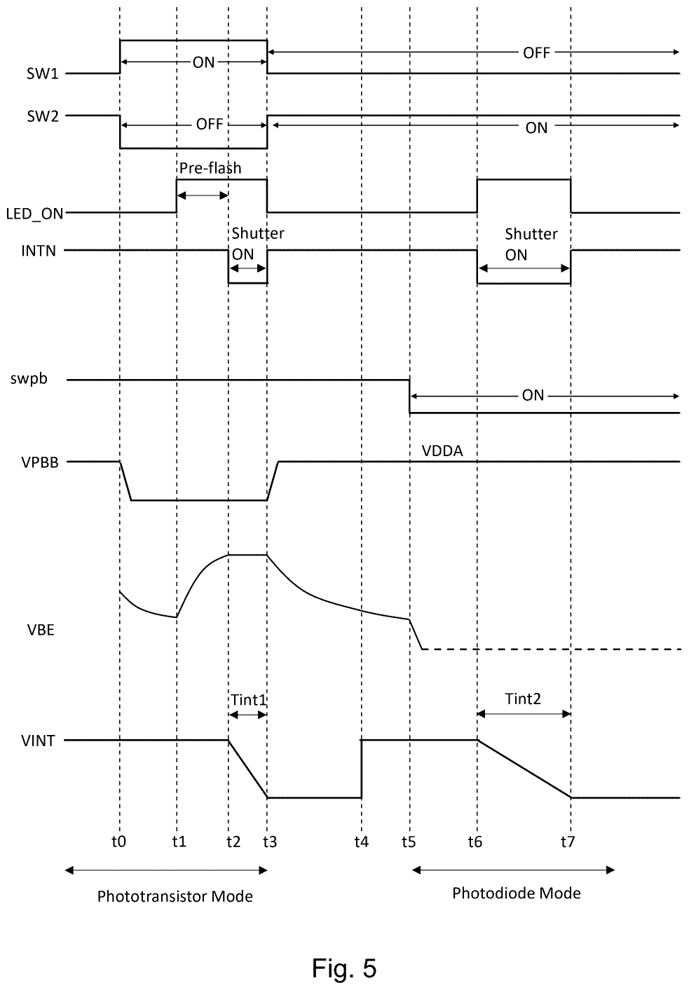

Refer to FIG. 4A and FIG. 5. FIG. 4A show operational schematic diagrams of a photodetector pixel circuit corresponding to FIG. 3, operating in the phototransistor mode, according to the present invention. FIG. 5 shows a simulation waveform diagram of an embodiment of a photodetector pixel circuit according to the present invention. Displayed in FIG. 5 are bias control signals sw1 and sw2, LED control signal LED_ON, shutter control signal INTN, swapping control signal swpb, biasing voltage VPBB, base-emitter voltage of the VBE photovoltaic BJT QP and the light intensity signal VINT.

In the phototransistor mode as shown in FIG. 4A, the swap switch M6 is OFF while the bias control switch M10 is ON and the bias control switch M9 is OFF. The biasing voltage VPBB is established to bias the biasing transistor M8 to provide a biasing current Ibias supplied from VDDA to the inverting node CGN, initiating the BJT feedback loop (i.e., the amplifier circuit 20 and the photovoltaic BJT QP) in response to light received on photovoltaic junction (i.e., the base-collector junction) to operate.

More specifically, during an integration phase (time t2 to t3) in the phototransistor mode, the bias current Ibias is provided through the inverting node CGN to bias the first amplifying transistor M4. This amplifies the voltage VB at the base of the photovoltaic BJT QP to generate an amplified signal VCGN at the inverting node CGN. The second amplifying transistor M5 amplifies the signal VCGN to regulate (e.g., pull-up herein) the voltage VE at the emitter of the photovoltaic BJT QP, biasing the photovoltaic BJT QP in the active region, which can be seen at the base-emitter voltage VBE rising to a stable level (t1-t2) as shown in FIG. 5. The storage capacitor C integrates the emitter current IE through the second amplifying transistor M5 to generate the light intensity signal VINT, whose level represents the intensity of the light after the integration (time t3).

FIG. 4B shows operational schematic diagrams of an embodiment of a photodetector pixel circuit, corresponding to FIG. 3, operating in photodiode mode according to the present invention. In the photodiode mode, as shown in FIG. 4B, the swap switch M6 is ON, while the bias control switch M10 is OFF and the bias control switch M9 is ON. The biasing circuit for the photovoltaic BJT QP is powered down (i.e., VPBB=VDDA), and the base of the photovoltaic BJT QP is electrically connected to the pre-bias node Shut_IN, corresponding to time t4 in FIG. 5.

In the photodiode mode, the inverting node CGN is pulled to ground by the first amplifying transistor M4 due to lacking of the bias current Ibias, and the emitter of the photovoltaic BJT QP is left floating (from t5 and beyond) due to the second amplifier transistor M5 also being off. Consequently, the amplifier circuit 20 is disabled, leading the photovoltaic BJT QP to function as a photodiode. Once light shines on the base of the photovoltaic BJT QP, a small base current IB is generated, as shown in FIG. 4B. Level of the base current IB depends on light intensity, with higher light intensity producing a higher IB. Pre-flash time is no longer needed in this photodiode mode. The LED's turning ON can coincide with the shutter time (e.g., t6, where LED_ON=1 and INTN=0), as shown in FIG. 5. The current to discharge the storage capacitor C is the base current IB.

More specifically, during an integration phase (time t6 to t7) in the photodiode mode, since the provision of the bias current Ibias is stopped, the second amplifier transistor M5 is controlled off, thereby electrically disconnecting the emitter of the photovoltaic BJT QP from the storage capacitor C. In the photodiode mode, the swap switch M6 is controlled to be conductive, allowing the storage capacitor C to integrate the base current IB through the swap switch M6 to generate the light intensity signal VINT, whose level represents the intensity of the light after the integration (time t7).

This photodiode mode can provide a high SNR signal since there is no β gain of the current (IB) integrated by the storage capacitor C, achieving about 15 dB higher SNR compared to phototransistor mode with a phototransistor current gain β of 30.

On the other hand, the integration time Tint1 (e.g., time t2-t3) required in the phototransistor mode for the light intensity signal VINT is shorter than integration time Tint2 (e.g., time t6-t7) required in the photodiode mode, which enables higher frame rate in the phototransistor. In one embodiment, the ratio of the integration time Tint2 to Tint1 is greater than 1 (i.e., Tint2>Tint1) and is related to (proportional to, in one embodiment) the phototransistor current gain β. Note that the shutter time corresponds to the aforementioned integration time.

This method allows the photodetector pixel circuit 300 with a single photovoltaic BJT QP to be selectively switched between two operating modes depending on application needs. For normal SNR applications such as tracking on non-glass surfaces, the phototransistor mode can be selected to save power while allowing high frame rate operation due to shorter integration time required. For high SNR applications such as tracking on glass or glossy surfaces, the photodiode mode can be selected to achieve better performance.

The present invention has been described in considerable detail with reference to certain preferred embodiments thereof. It should be understood that the description is for illustrative purpose, not for limiting the scope of the present invention. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. Furthermore, those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. The spirit of the present invention should cover all such and other modifications and variations, which should be interpreted to fall within the scope of the following claims and their equivalents.

What is claimed is:

1. A photodetector pixel circuit, comprising:
a phototransistor, including a photovoltaic junction, wherein the photovoltaic junction generates a junction current in response to received light, the level of the junction current being related to the intensity of the light; and
a storage capacitor, coupled to the phototransistor for detecting the intensity of the light;
wherein in a phototransistor mode, the storage capacitor is configured to integrate an amplified current, generated by the phototransistor amplifying the junction current with a phototransistor current gain which is larger than 1, to generate a light intensity signal representing the intensity of the light,
wherein in a photodiode mode, the storage capacitor is configured to integrate the junction current to generate the light intensity signal.

2. The photodetector pixel circuit of claim 1, wherein for generating the light intensity signal in response to a same light intensity, a first integration time is required in the phototransistor mode and a second integration time is required in the photodiode mode, wherein a ratio between the second integration time to the first integration time is greater than 1 and is related to the phototransistor current gain.

3. The photodetector pixel circuit of claim 1, wherein a signal-to-noise ratio (SNR) of the light intensity signal is higher in the photodiode mode than in the phototransistor mode.

4. The photodetector pixel circuit of claim 1, wherein the phototransistor is a photovoltaic bipolar-junction-transistor (BJT), wherein the photovoltaic junction corresponds to a base-collector junction of the photovoltaic BJT, wherein the junction current corresponds to a base current flowing through the base of the photovoltaic BJT, wherein the amplified current corresponds to an emitter current flowing through the emitter of the photovoltaic BJT.

5. The photodetector pixel circuit of claim 1, further comprising:
a swap switch, configured to conduct the junction current to integrate the storage capacitor in the photodiode mode.

6. The photodetector pixel circuit of claim 5, further comprising:
an amplifier circuit, configured to, in the phototransistor mode, amplify a voltage at the base of the photovoltaic BJT to regulate a voltage at the emitter of the photovoltaic BUT to a level, whereby the photovoltaic BJT is biased in an active region to provide the phototransistor current gain and to conduct the storage capacitor to the amplified current for integration.

7. The photodetector pixel circuit of claim 6, further comprising:
a bias current;
wherein in the phototransistor mode, the bias current is provided to bias the amplifier circuit to operate;
wherein in the photodiode mode, provision of the bias current for biasing the amplifier circuit is stopped, thereby the amplified current stops being generated and cut off from the storage capacitor.

8. The photodetector pixel circuit of claim 7, further comprising:
a reset switch, configured to reset the light intensity signal before the storage capacitor being integrating in the phototransistor mode or the photodiode mode; and
an integration switch, configured to conduct the storage capacitor for being integrating in the phototransistor mode or the photodiode mode.

9. The photodetector pixel circuit of claim 8, further comprising a pre-bias transistor, wherein the amplifier circuit includes a first amplifying transistor and a second amplifying transistor, wherein
the pre-bias transistor is connected between a supply voltage and a pre-bias node,
the integration switch is connected between the pre-bias node and the storage capacitor,
the reset switch is connected between the storage capacitor and the supply voltage,
the swap switch is connected between the pre-bias node and the base of the photovoltaic BJT,
a gate and a drain of the first amplifying transistor are connected to the base of the photovoltaic BJT and an inverting node respectively, and
a gate, a drain and a source of the second amplifying transistor are connected to the inverting node, the pre-bias node and the emitter of the photovoltaic BJT respectively.

10. The photodetector pixel circuit of claim 9,
wherein during an integration phase in the phototransistor mode, the bias current is provided through the inverting node to bias the first amplifying transistor which amplifies the voltage at the base of the photovoltaic BJT to generate an amplified signal on the inverting node, and the second amplifying transistor amplifies the amplified signal to regulate the voltage at the emitter of the photovoltaic BJT for biasing the photovoltaic BJT in the active region, wherein the storage capacitor integrates the emitter current through the second amplifying transistor to generate the light intensity signal, and wherein the swap switch is controlled to be off;
wherein during an integration phase in the photodiode mode, provision of the bias current is stopped, thereby cutting off the second amplifier transistor to electrically disconnect the emitter of the photovoltaic BJT from the storage capacitor, and wherein the swap switch is controlled to be conductive, thereby the storage capacitor integrates the base current through the swap switch to generate the light intensity signal.
